(19) United States
(12) Patent Application Publication
(10) Pub. No.: US 2014/0342344 A1
(43) Pub. Date: Nov. 20, 2014

(54) APPARATUS AND METHOD FOR SENSORY-TYPE LEARNING

(71) Applicants: Young Hoon Lee, Daejeon (KR); Chan Hui Kang, Yongin-si (KR); Jong Cheol Kim, Seoul (KR); Hyun Ho Kim, Seoul (KR)

(72) Inventors: Young Hoon Lee, Daejeon (KR); Chan Hui Kang, Yongin-si (KR); Jong Cheol Kim, Seoul (KR); Hyun Ho Kim, Seoul (KR)

(73) Assignee: KT CORPORATION, Seongnam-si (KR)

(21) Appl. No.: 14/365,464

(22) PCT Filed: Feb. 28, 2012
(86) PCT No.: PCT/KR2012/001492

§ 371 Date: Jun. 13, 2014

(30) Foreign Application Priority Data
Dec. 21, 2011 (KR) 10-2011-0139497

(51) Int. Cl. G09B 5/02; G06T 13/80; G06F 3/01

(52) U.S. Cl. CPC G09B 5/02; G06F 3/017; G06T 13/80
USPC 434/365

(57) ABSTRACT

An apparatus and a method for sensory-type learning are disclosed. An apparatus for sensory-type learning comprises: a video divider configured to divide a video of a recorded learner into a plurality of blocks, and divide the video which has been divided into a plurality of blocks into previously set time intervals; a differential video extractor configured to extract a differential video; an object domain generator configured to generate a first object domain, which is a single object domain; a contact determiner configured to determine whether the first object domain came into contact with a second object domain pertaining to a background object appearing on a screen; and a movement controller configured to apply the change in animation to the background object and control the apparatus for sensory-type learning to execute a previously set movement.

### CROSS-REFERENCE TO RELATED APPLICATIONS

This is a National Phase Application of International Patent Application No. PCT/KR2012/001492, filed Feb. 28, 2012, claiming priority from Korean Patent Application No. 10-2011-0139497, filed Dec. 21, 2011. The disclosures of the prior applications are hereby incorporated in their entireties by reference.

### BACKGROUND

1. Technical Field

Apparatuses and methods consistent with exemplary embodiments relate to a learning apparatus and method, and more specifically to an apparatus and method for sensory-type learning.

2. Background Art

The keyboard, mouse and joystick are some of the main apparatuses for controlling a game.

The above control devices are general-purpose apparatuses that are not capable of fully enhancing the peculiar features of each game, for example, an airplane game, an automobile game, a fighting game, etc.

Moreover, these apparatuses are used in a rather static fashion by having the user manipulate the apparatuses in a seated position in a chair, and using these apparatuses on a chair for an extended period of time is physically stressful to the user's body and can easily cause fatigue to the user.

Recently, sensory-type games have been introduced, and will continue to be developed, in order to cope with the increasingly sophisticated game systems and to meet the growing needs of the consumers.

Various kinds of available sensory-type games include racing games that are played watching a monitor screen in a real car interior, shooting games that are played by pulling a trigger toward enemies in the monitor screen by use of a real-gun-looking device, games that use a ski board to slalom downhill from a mountain in the monitor screen, and fire-fighting games that have a fire extinguisher of a fire engine arranged therein to put out the fire in the monitor screen by use of the fire extinguisher.

Moreover, there have been active attempts to apply these sensory-type games to learning environments to enhance the learning effects.

However, these sensory-type games or learning methods require costly hardware and a large space. In other words, the high costs inevitably increase the price that users have to pay, and the large space requirement becomes a great burden in arranging the various kinds of games or learning contents.

Korean Utility Model 20-239844 (SIMULATION GAME SYSTEM USING MACHINE VISION AND PATTERN-RECOGNITION) discloses recording a human motion that is within a chroma-key screen (background for extracting outside shade), comparing an imitation of a dance of a video character that is pre-set as a base dance with a still reference image, and scoring a result of the comparison.

In order to realize this technology, however, it is essential to have the chroma-key screen to distinguish the background from a person, and it is possible to analyze the type of motion of a user if changes in color, brightness and chroma that are generated when the user appears are detected. Therefore, it is absolutely imperative that there is no moving object, which may cause confusion between human body and an object, in front of a camera, making it difficult for users to readily enjoy the sensory-type game or learning.

### SUMMARY

Contrived to solve the above problems of the conventional art, the present invention provides an apparatus and a method for sensory-type learning that can enhance game features to improve a learning effect of a learner, at a low cost without wasted space while not using a chroma-key screen or blue screen.

Objects of the present invention are not restricted to what is described above, and any other objects not mentioned herein shall become apparent through the following description.

An aspect of the present invention features an apparatus for sensory-type learning that includes: a video divider configured to divide a video of a recorded learner into a plurality of blocks and divide the video divided into the plurality of blocks into predetermined time intervals; a differential video extractor configured to extract a differential video by comparing changes in the video divided into the time intervals; an object domain generator configured to generate a first object domain by connecting the extracted differential videos, the first object domain being a single object domain; a contact determiner configured to determine whether the first object domain came into contact with a second object domain pertaining to a background object appearing on a screen; and a movement controller configured to apply the change in animation to the background object and control the apparatus for sensory-type learning to perform a predetermined operation in accordance with the change in animation, if it is determined that the first object domain came into contact with the second object domain.

The video divider can be configured to divide a current video as an (n)th frame and a next video of the current video as an (n+1)th frame when the video divider divides the video divided into the plurality of blocks into predetermined time intervals.

The object domain generator can be configured to generate the single object domain by extracting a 3-dimensional vector based on a result of comparing the changes in the video extracted by the differential video extractor and by performing domain optimization for a domain in which the differential videos are connected with one another based on connectivity of coordinate values distributed in the 3-dimensional vector.

The object domain generator can be configured to extract the 3-dimensional vector by searching for blocks that are identical or similar to a reference time frame by use of blocks of the extracted differential video.

The object domain generator can be configured to generate the second object domain by dividing an image of the background object into a plurality of blocks.

The size of the blocks constituting the second object domain can be identical to that of blocks constituting the first object domain.

The size of the blocks constituting the second object domain can be different from that of blocks constituting the first object domain.

The contact determiner can be configured to determine an amount of contact by use of at least one from among a percentage value of domains where the first object domain and the second object domain overlap with each other and a percentage value of a number of overlapped images in the video divided into the predetermined time intervals.

The movement controller can be configured to predict a movement direction of the first object domain based on the 3-dimensional vector extracted by the object domain generator, when the first object domain comes in contact with the second object domain.

The movement controller can be configured to apply the change in animation to the background object in accordance with the predicted movement direction of the first object domain.

Another aspect of an exemplary embodiment features a method for sensory-type learning that includes: (a) dividing a video of a recorded learner into a plurality of blocks; (b) dividing the video divided into the plurality of blocks into predetermined time intervals; (c) extracting a differential video by comparing changes in the video divided into the time intervals; (d) extracting a 3-dimensional vector based on a result of comparing the changes in the video, and generating a first object domain based on connectivity of coordinate values distributed in the 3-dimensional vector, the first object domain having differential videos connected with one another; (e) determining whether the first domain object is in contact with a second object domain, the second object domain having an image of a background object appearing on a screen divided into a plurality of blocks; (f) applying a change in animation to the background object and having an apparatus for sensory-type learning perform a predetermined operation in accordance with the change in animation, if it is determined that the first object domain is in contact with the second object domain.

In the operation (b), the video divided into the plurality of blocks can be divided into the predetermined time intervals so as to have 30 frames per second.

The operation (e) can include: (e-1) calculating a percentage value of domains where the first object domain and the second object domain overlap with each other; (e-2) calculating a percentage value of the number of overlapped images in a plurality of videos divided into the predetermined time intervals; (e-3) determining the contact by use of at least one from among the value calculated in the operation (e-1) and the value calculated in the operation (e-2).

Details of the present invention will become apparent through the embodiments described below together with the accompanying drawings.

Nevertheless, the present invention shall not be limited to the embodiments disclosed below, but can be embodied in various other forms. The embodiments are provided to complete the disclosure of the present invention and to have the scope of the invention understood by persons of ordinary skill in the art to which the present invention pertains.

According to the apparatus and the method for sensory-type learning of the present invention, the features of a game can be enhanced, and the learning effect of a learner can be improved, at a low cost without wasting the space.

Moreover, since a movement of an object caught in a video inputted through a video camera can be objectified, the load of computation can be minimized by, for example, dividing different body parts of the learner into different codes.

Furthermore, since the learning process proceeds by enhancing the game-like features so that the learner can actively participate in the learning, the learning can be more fun and more engaging.

### BRIEF DESCRIPTION OF THE DRAWINGS

FIG. 1 is a brief illustration of an apparatus for sensory-type learning in accordance with an embodiment of the present invention.

FIG. 2 is a block diagram illustrating the configuration of Kibot in accordance with an embodiment of the present invention.

FIGS. 3 and 4 are flow diagrams illustrating a method for sensory-type learning in accordance with an embodiment of the present invention.

FIG. 5 shows how a contact is determined by a contact determination unit in accordance with an embodiment of the present invention.

FIG. 6 illustrates a learning screen in accordance with an embodiment of the present invention.

FIG. 7 illustrates a learning screen in accordance with another embodiment of the present invention.

### DETAILED DESCRIPTION

Since there can be a variety of permutations and embodiments of the present invention, certain embodiments will be illustrated and described with reference to the accompanying drawings.

This, however, is by no means to restrict the present invention to certain embodiments, and shall be construed as including all permutations, equivalents and substitutes covered by the ideas and scope of the present invention.

Throughout the description of the present invention, when describing a certain relevant conventional technology is determined to evade the point of the present invention, the pertinent detailed description will be omitted.

Identical or corresponding elements are given the same reference numerals, regardless of the figure number, and any redundant description of the identical or corresponding elements are not repeated.

When one element is described as being “connected” to another element, it shall be construed as being “directly connected” to the other element but also as possibly being “indirectly connected” with another element in between.

Moreover, when a certain portion is described to “comprise” or “include” a certain element, it shall not be construed to preclude any presence or possibility of another element but shall be construed that another element can be further included.

Hereinafter, some embodiments will be described in detail with reference to the accompanying drawings.

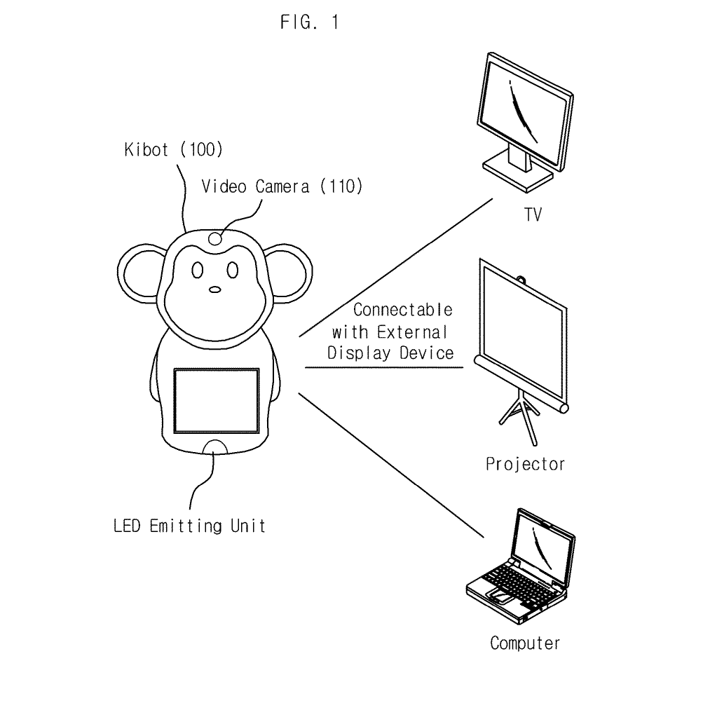

FIG. 1 is a brief illustration of an apparatus for sensory-type learning in accordance with an embodiment of the present invention.

An apparatus for sensory-type learning 100 in accordance with an embodiment of the present invention can allow a learner to proceed with learning through bodily motions while watching the appearance of the learner displayed through a video camera and can have a character shape that is friendly to learning children.

Hereinafter, the apparatus for sensory-type learning 100 in accordance with an embodiment of the present invention will be referred to as Kids Robot, or in short, Kibot 100.

Kibot 100 in accordance with an embodiment of the present invention can include a video camera for capturing an image of a learner and a display device for displaying the image of the learner captured by the video camera.

Here, it is possible that Kibot 100 has the video camera installed therein or is connected with a USB type of video camera.

Moreover, the display device can also be located at a front portion of Kibot 100 to display the image of the learner or can be connected with an external display device and transfer motions of the learner captured through the video camera to the external display device.

In such a case, it is possible that the learner proceed with the learning with a bigger screen than the display device installed in Kibot 100.

Moreover, Kibot 100 can include a light emitting diode (LED) emitting unit and an audio output device, and can perform audio output (sound effects) and operations corresponding to the learner's movement, for example, changing the color of the LED emitting unit, adjusting the frequency of lighting, etc., while continuing with the learning through the movement of the learner.

For this, Kibot 100 can extract the learner's movement captured through the video camera as a 3 dimensional vector, have the learner's movement interact with a background object displayed on a learning screen according to the learner's movement, and display the interacted learner's movement on the display device.

Moreover, since Kibot 100 can react with the above-described various operations according to the learner's movement and as the learning process proceeds based on the learner's movement, the learner can be encouraged to participate in the learning voluntarily with much interest.

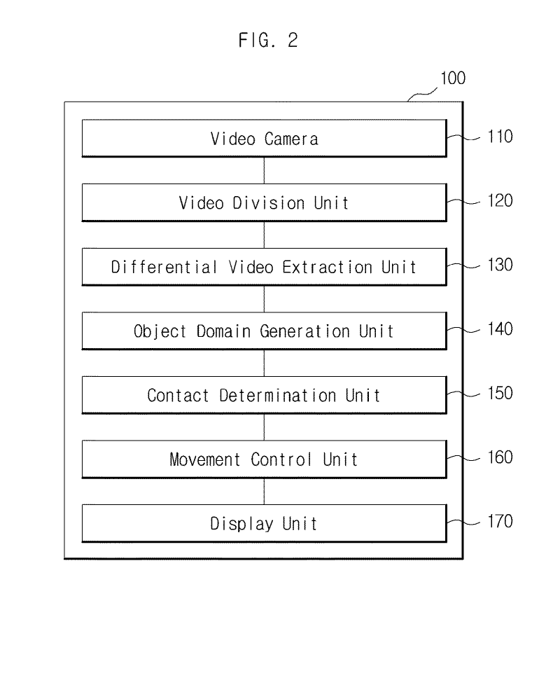

FIG. 2 is a block diagram illustrating the configuration of Kibot 100 in accordance with an embodiment of the present invention.

Kibot 100 in accordance with an embodiment of the present invention includes a video camera 110, a video division unit 120, a differential video extraction unit 130, an object domain generation unit 140, a contact determination unit 150, a movement control unit 160 and a display unit 170.

Describing each of these elements, the video camera 110 captures images of the learner in real time, and the video division unit 120 divides the real-time captured video of the learner into a plurality of blocks.

For example, the video division unit 120 can divide the video of the learner captured through the video camera 110 into 8×8 blocks, or into various block sizes, such as 4×4, 16×16, 32×32, etc.

The smaller the blocks are, the more accurately the learner's movement can be assessed. However, the increased accuracy can affect the process speed, and thus it would be preferable to consider a suitable number of blocks and a pertinent process speed according to the type of learning and processing method.

Hereinafter, dividing the learner's video captured through the video camera 110 into 8×8 blocks will be described.

Moreover, the video division unit 120 divides the plurality of divided blocks into predetermined time intervals.

For example, the video division unit 120 can divide the video that has been divided into 8×8 blocks into time intervals so as to have 30 frames per second. Moreover, the video can be divided into time intervals to have less than or more than 30 frames per second.

Hereinafter, it will be described that the video division unit 120 divides each frame of 30 frames-per-second video into 8×8 blocks.

The differential video extraction unit 130 extracts a differential video by comparing changes in the video divided into 30 frames per second (each frame being divided into 8×8 blocks) by the video division unit 120.

Specifically, the differential video extraction unit 130 can extract the differential video by comparing the changes in the video, based on time, between an (n)th frame, which is a current video, and an (n+1)th frame, which is the next video of the current video, in the 30 frames per second.

Here, the differential video can be constituted with changed blocks in two videos (n, N+1), which are divided into 8×8 blocks.

The object domain generation unit 140 generates a single object domain by connecting the differential videos extracted by the differential video extraction unit 130.

Specifically, the object domain generation unit 140 extracts a 3-dimensional vector by searching for blocks that are identical or similar to a reference time frame by use of the differential video extracted by the differential video extraction unit 130.

Here, the object domain generation unit 140 can express a direction, in which the learner's movement is changed, in a 3-dimensional victor that has 2-dimensional x and y values and a z value of a time axis.

Afterwards, by searching for a domain (blocks), in which differential videos are connected with one another, based on connectivity of coordinate values distributed in the 3-dimensional vector and performing domain optimization for the searched domain, the object domain generation unit 140 can generate a single object domain (“learner object domain” hereinafter) that is a portion in which movement has occurred among the videos captured from the learner and in which the movement is changed.

Moreover, the object domain generation unit 140 can generate an object domain for a background object appearing in a game screen.

The object domain generation unit 140 can generate the object domain in which an image of the background object is divided into a plurality of blocks (hence referred to as “background object domain” hereinafter), and the background object domain can be divided into 8×8 blocks, or any various block sizes such as 4×4, 16×16, etc.

The smaller the blocks of the background object domain are, overlapping of the learner object domain and the background object domain can be determined more accurately. However, the increased accuracy can affect the process speed, and thus it would be preferable to consider a suitable number of divided blocks and a pertinent process speed according to the type of learning and processing method.

The contact determination unit 150 determines whether the learner object domain and the background object domain came into contact.

For this, the contact determination unit 150 can determine the contact by use of at least one of a percentage value of domains where the learner object domain and the background object domain overlap with each other and a percentage value of the number of overlapped images in the 30 frames-per-second video.

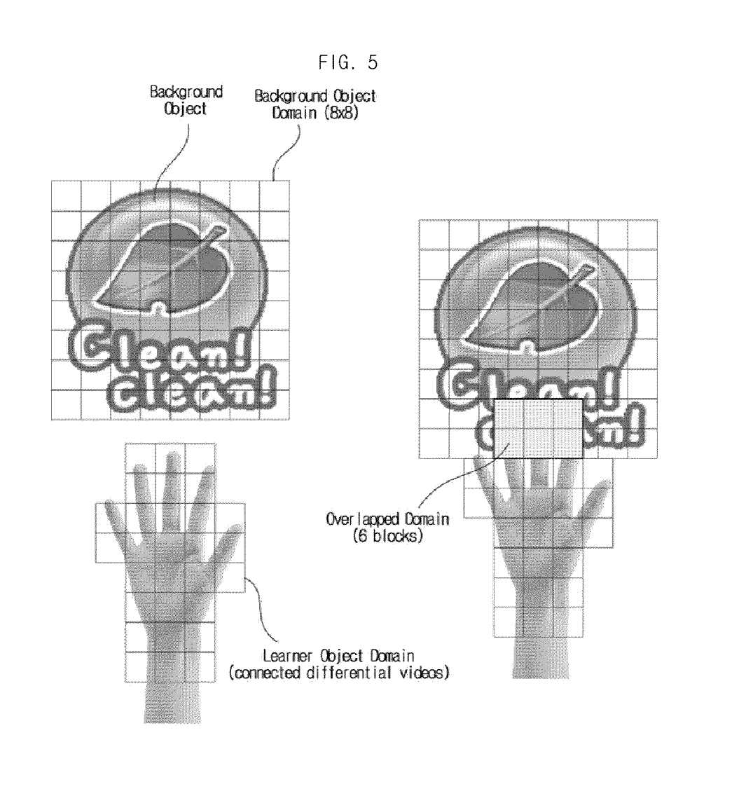

This will be described later in more detail with reference to FIG. 5.

The movement control unit 160 can predict a movement direction of the learner object domain based on the 3-dimensional vector extracted from the object domain generation unit 140.

That is, when the learner object domain and the background object domain come into contact with each other, the movement control unit 160 can predict the movement direction of the learner object domain and apply a change in animation to the background object according to the predicted movement direction.

For example, in the case where the movement direction of the learner object domain is predicted to be downward when the learner object domain comes in contact with the background object domain, the movement control unit 160 can apply a change in animation that the background object falls downwardly.

Thereafter, the movement control unit 160 can apply the change in animation to the background object and then control Kibot 100 to perform a predetermined operation according to the change in animation.

For example, in the case where the animation change of the background object falling downwardly is applied, the movement control unit 160 can control Kibot 100 to turn on the LED emitting unit or output an audio announcement that says “Good job! Mission accomplished!”

The display unit 170 can be placed at the front portion of Kibot 100 to display the motions of the learner captured through the video camera 110, and can also display the image of the learner by overlapping with the game screen.

The elements illustrated in FIG. 2 in accordance with an embodiment of the present invention refer to software or hardware, such as Field Programmable Gate Array (FPGA) or Application Specific Integrated Circuit (ASIC), and perform their respective predetermined functions.

Nevertheless, these elements are not limited to such software or hardware, and the elements can be each configured to be present in an addressable storage medium and to play back one or more processors.

Therefore, in an example, the elements can include elements such as software elements, object-oriented software elements, class elements and task elements, processes, functions, attributes, procedures, subroutines, program code segments, drivers, firmware, microcode, circuit, data, database, data structures, tables, arrays and variables.

The elements and functions provided within the elements can be combined to a smaller number of elements or divided into additional elements.

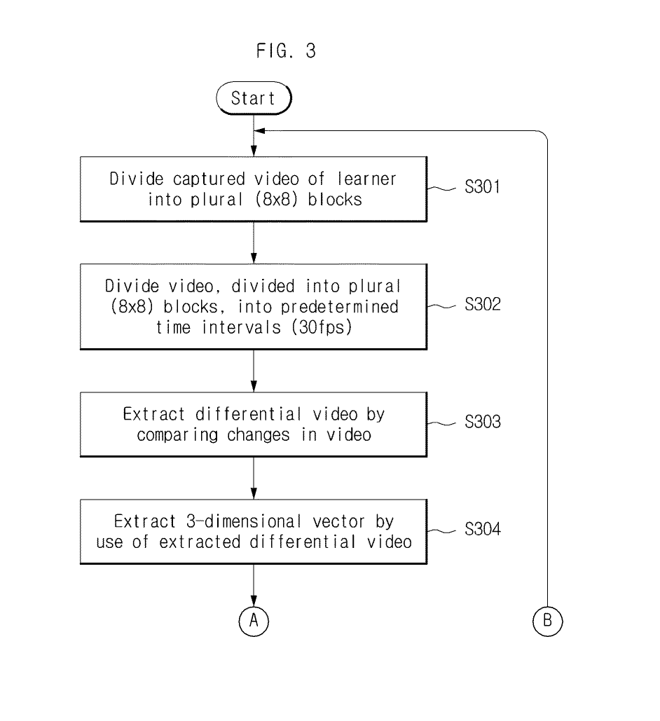

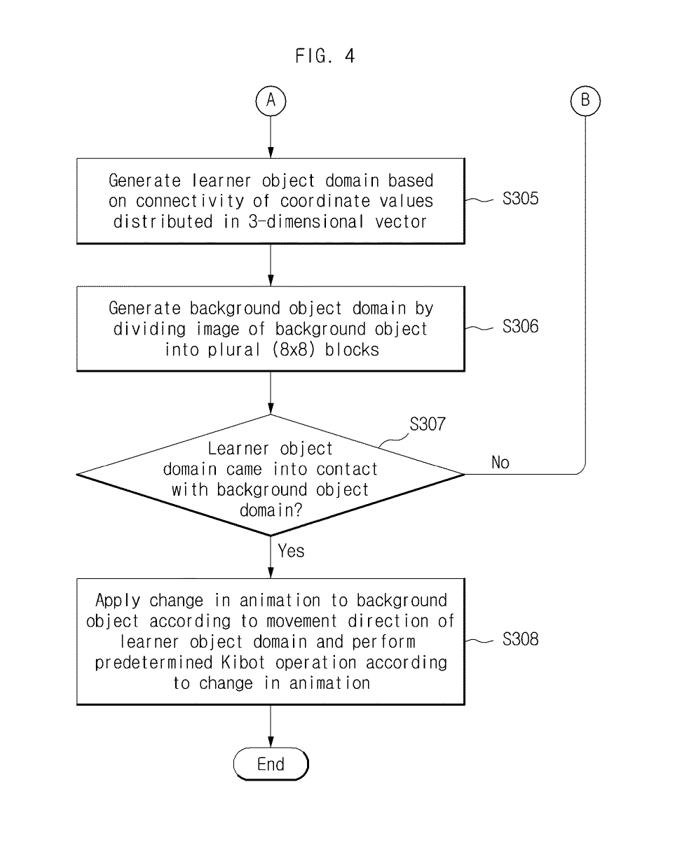

FIGS. 3 and 4 are flow diagrams illustrating a method for sensory-type learning in accordance with an embodiment of the present invention.

Hereinafter, the flow diagram of FIGS. 3 and 4 will be described with reference to Kibot 100 illustrated in FIG. 1.

Kibot 100 divides (i.e., spatially divides) a video of the learner captured in real time through the video camera 110 into 8×8 blocks (S301).

It shall be appreciated that the captured video of the learner can be divided into various block sizes, for example, 4×4, 16×16, 32×32, etc.

After S301, Kibot 100 divides (i.e., temporally divides) the video, which has been divided into 8×8 blocks, into time intervals so as to have 30 frames per second (S302).

After S302, Kibot 100 extracts a differential video by comparing changes in the video divided into 30 frames per second (each frame being divided into 8×8 blocks) (S303).

After S303, Kibot 100 extracts a 3-dimensional vector by searching for blocks that are identical or similar to a reference time frame by use of the extracted differential video (S304).

After S304, by searching for a domain (blocks), in which differential videos are connected with one another, based on connectivity of coordinate values distributed in the 3-dimensional vector and performing domain optimization for the searched domain, Kibot 100 generates a learner object domain, which is a portion in which movement has occurred among the videos captured from the learner and in which the movement is changed (S305).

After S305, Kibot 100 generates a background object domain by dividing an image of a background object appearing in a game screen into 8×8 blocks (S306).

It shall be appreciated that the background object domain can be divided into various other block sizes than 8×8 blocks, for example, 4×4, 16×16, etc.

After S306, Kibot 100 determines whether the learner object domain came into contact with the background object domain (S307).

Here, Kibot 100 can determine the contact by use of at least one of a percentage value of domains where the learner object domain and the background object domain overlap with each other and a percentage value of the number of overlapped images in the 30 frames-per-second video.

If it is determined as a result of S307 that the learner object domain is overlapped with, that is, in contact with, the background object domain, Kibot 100 applies a change in animation to the background object according to a movement direction of the learner object domain and performs a predetermined operation according to the change in animation (S308).

FIG. 5 shows how a contact is determined by the contact determination unit in accordance with an embodiment of the present invention.

Illustrated are a background object domain, which is divided into 8×8 blocks (64 blocks total), and a learner object domain, which consists of 29 blocks.

It shall be appreciated that the learner object domain may not necessarily have the shape of a hand, as illustrated in FIG. 5, since the learner object domain has differential videos connected therein, but for the convenience of description, the learner object domain is illustrated herein to have the shape similar to a hand.

As illustrated, there are 6 blocks that have the learner object domain and the background object domain overlapped with each other, and the percentage value of these 6 blocks is calculated to be (6/64)×100%.

Moreover, the contact between the learner object domain and the background object domain can be determined by calculating the percentage value of how many frames are overlapped, as in FIG. 5, in 30 frames per second.

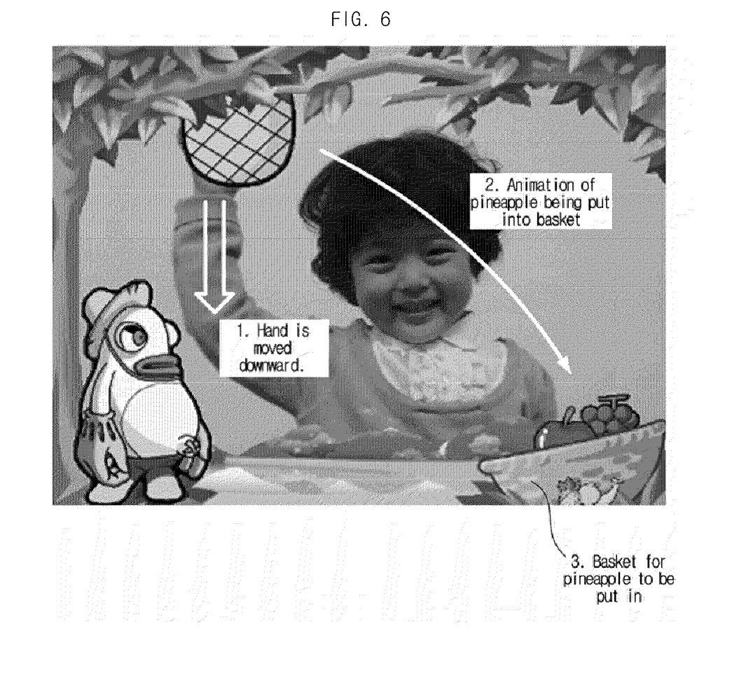

FIG. 6 illustrates a learning screen in accordance with an embodiment of the present invention.

In the case where a learner moves a hand downward when the hand is overlapped with a pineapple that is hung on a tree, an animation can be performed to put the pineapple hung on the tree in a basket at a bottom of a screen.

Here, Kibot 100 can output an English voice “pineapple” and turn on the LED emitting unit several times per second.

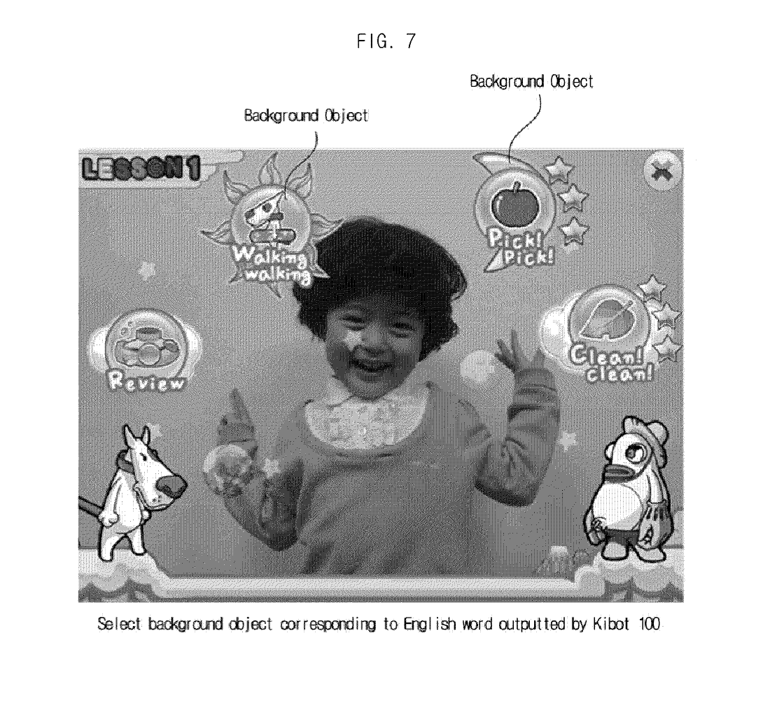

FIG. 7 illustrates a learning screen in accordance with another embodiment of the present invention.

When Kibot 100 outputs a particular word in English pronunciation, the learner can use a hand thereof to make contact with a corresponding background object and proceed with learning.

For example, in the case where the word “clean” is outputted in English pronunciation, the learner can use the hand to select the “clean” background object having a leaf drawn thereon.

Then, Kibot 100 can output an audio announcement saying “Wow! Good job! Shall we go to the next step?” and continue with the learning, at which the LED emitting unit of Kibot 100 can be turned on several times and a fanfare can be outputted.

In case the learner selects another background object instead of the “clean” background object on which the leaf is drawn, Kibot 100 can output an audio message saying “Why don't you select something else?” and motivate the learner for voluntary participation.

Hitherto, the above description has been provided in illustrative purposes of the technical ideas of the present invention, and it shall be appreciated that a large number of permutations and modifications of the present invention are possible without departing from the intrinsic features of the present invention by those who are ordinarily skilled in the art to which the present invention pertains.

Accordingly, the disclosed embodiments of the present invention are for illustrative purposes, rather than restrictive purposes, of the technical ideas of the present invention, and the scope of the technical ideas of the present invention shall not be restricted by the disclosed embodiments.

The scope of protection of the present invention shall be interpreted through the claims appended below, and any and all equivalent technical ideas shall be interpreted to be included in the claims of the present invention.

The present invention can be utilized in telecommunications and robot industries.

1. An apparatus for sensory-type learning, comprising:
a video divider configured to divide a video of a recorded learner into a plurality of blocks and divide the video divided into the plurality of blocks into predetermined time intervals;
a differential video extractor configured to extract a differential video by comparing changes in the video divided into the time intervals;
an object domain generator configured to generate a first object domain by connecting the extracted differential videos, the first object domain being a single object domain;
a contact determiner configured to determine whether the first object domain came into contact with a second object domain pertaining to a background object appearing on a screen; and
a movement controller configured to apply a change in animation to the background object and control the apparatus for sensory-type learning to perform a predetermined operation in accordance with the change in animation, if it is determined that the first object domain came into contact with the second object domain.

2. The apparatus of claim 1, wherein the video divider is configured to divide a current video as an (n)th frame and a next video of the current video as an (n+1)th frame when the video divider divides the video divided into the plurality of blocks into predetermined time intervals.

3. The apparatus of claim 1, wherein the object domain generator is configured to generate the single object domain by extracting a 3-dimensional vector based on a result of comparing the changes in the video extracted by the differential video extractor and by performing domain optimization for a domain in which the differential videos are connected with one another based on connectivity of coordinate values distributed in the 3-dimensional vector.

4. The apparatus of claim 3, wherein the object domain genearator is configured to extract the 3-dimensional vector by searching for blocks that are identical or similar to a reference time frame by use of blocks of the extracted differential video.

5. The apparatus of claim 1, wherein the object domain generator is configured to generate the second object domain by dividing an image of the background object into a plurality of blocks.

6. The apparatus of claim 1, wherein the size of the blocks constituting the second object domain is identical to that of blocks constituting the first object domain.

7. The apparatus of claim 1, wherein the size of the blocks constituting the second object domain is different from that of blocks constituting the first object domain.

8. The apparatus of claim 1, wherein the contact determiner is configured to determine an amount of contact by use of at least one from among a percentage value of domains where the first object domain and the second object domain overlap with each other and a percentage value of a number of overlapped images in the video divided into the predetermined time intervals.

9. The apparatus of claim 3, wherein the movement controller is configured to predict a movement direction of the first object domain based on the 3-dimensional vector extracted by the object domain generator, when the first object domain comes in contact with the second object domain.

10. The apparatus of claim 9, wherein the movement controller is configured to apply the change in animation to the background object in accordance with the predicted movement direction of the first object domain.

11. A method for sensory-type learning, comprising:
(a) dividing a video of a recorded learner into a plurality of blocks;
(b) dividing the video divided into the plurality of blocks into predetermined time intervals;
(c) extracting a differential video by comparing changes in the video divided into the time intervals;
(d) extracting a 3-dimensional vector based on a result of comparing the changes in the video, and generating a first object domain based on connectivity of coordinate values distributed in the 3-dimensional vector, the first object domain having differential videos connected with one another;
(e) determining whether the first domain object is in contact with a second object domain, the second object domain having an image of a background object appearing on a screen divided into a plurality of blocks;
(f) applying a change in animation to the background object and having an apparatus for sensory-type learning perform a predetermined operation in accordance with the change in animation, if it is determined that the first object domain is in contact with the second object domain.

12. The method of claim 11, wherein, in the operation (b), the video divided into the plurality of blocks is divided into the predetermined time intervals so as to have 30 frames per second.

13. The method of claim 11, wherein, the operation (e) comprises:
(e-1) calculating a percentage value of domains where the first object domain and the second object domain overlap with each other;
(e-2) calculating a percentage value of the number of overlapped images in a plurality of videos divided into the predetermined time intervals;
(e-3) determining the contact by use of at least one of from among the value calculated in the operation (e-1) and the value calculated in the operation (e-2).
